(19) United States
(12) Patent Application Publication
(10) Pub. No.: US 2017/0237611 A1
(43) Pub. Date: Aug. 17, 2017

(54) SYSTEM FOR CONTROLLING TERMINAL EQUIPMENT, GATEWAY AND METHOD OF ADDING NEW TERMINAL EQUIPMENT

(71) Applicant: INSTITUTE FOR INFORMATION INDUSTRY, Taipei City (TW)

(72) Inventor: Mao-Chi Huang, TAIPEI CITY (TW)

(21) Appl. No.: 15/091,050

(22) Filed: Apr. 5, 2016

(30) Foreign Application Priority Data
Feb. 17, 2016 (TW) 105104571

(51) Int. Cl. H04L 12/24; H04W 4/00

(52) U.S. Cl. CPC H04L 41/0806; H04L 41/085; H04W 4/008; H04L 41/0846; H04W 88/16

(57) ABSTRACT

Disclosed is a system for controlling terminal equipment comprising at least one terminal equipment, a gateway and a method for adding new terminal equipment. The terminal equipment uses a communication protocol. The gateway is coupled to the terminal equipment for generating a constructive command corresponding to at least one terminal equipment having a diversity of communication formats. The gateway has a read API, a write API, a command generating unit and a configuration file. The configuration file comprises read-write commands for the terminal equipment. The gateway generates the constructive command corresponding to the terminal equipment according to the configuration file. The communication generating unit of the gateway uses the constructive command to control or access the terminal equipment through the read API or the write API. Accordingly, terminal equipment can be easily added for being controlled by the gateway.

### BACKGROUND OF THE INVENTION

1. Field of the Invention

The instant disclosure relates to a method for quickly adding new terminal equipment; in particular, to a system for controlling terminal equipment having a diversity of communication formats, a gateway and a method for adding new terminal equipment.

2. Description of Related Art

With the development of the Internet, people today can remotely control all kinds of terminal equipment. Refer to FIG. 1. Kinds of terminal equipment 2, such as automatic shutters, the infrared ray (IR) adaptor, the electricity meter, the lamp, the exhaust fan, the sensor and the visitor counter, can be connected to the gateway 3 and controlled by the remote control apparatus 1. The gateway 3 shown in FIG. 1 can be a wired gateway or a wireless gateway, which is connected to the remote control apparatus 1 via the network 4, such as the Internet. However, different terminal equipment 2 may need to use various communication protocols and have various transmission formats. For example, with respect to a ZigBee adaptor, the gateway 3 needs a communication program under the ZigBee communication protocol. On the other hand, with respect to the terminal equipment using other communication protocols, such as the terminal equipment using the RS485 communication protocol or the RS232 communication protocol, the gateway 3 needs a communication program under the RS485 communication protocol or the RS232 communication protocol.

Thus, it is difficult for the gateway to communicate with different kinds of controlled terminal equipment, because the gateway needs communication programs under various communication protocols. In other words, it takes time for an engineer to write different communication programs under various communication protocols each time when new terminal equipment is added, which results in difficulty adding new terminal equipment, and results in difficulty maintaining the connection program that becomes more complex every time new terminal equipment is added. In addition, it is not easy to find the error that may generate during the data transmission between a gateway and the controlled terminal equipment, so that it is difficult to remove the error.

### SUMMARY OF THE INVENTION

The instant disclosure provides a system for controlling terminal equipment, a gate and a method for adding new terminal equipment, which uses constructive commands in a diversity of communication formats to easily add new terminal equipment, such that the newly added terminal equipment can be controlled by the gateway.

The instant disclosure provides a system for controlling terminal equipment. The system for controlling terminal equipment comprises at least one terminal equipment and a gateway. The terminal equipment uses a communication protocol. The gateway is coupled to the terminal equipment, and generates a constructive command corresponding to the terminal equipment having a diversity of communication formats. The gateway has a read application programming interface (API), a write API, a command generating unit and a configuration file, and the configuration file comprises a read-write command for the terminal equipment. The command generating unit of the gateway generates the constructive command corresponding to the terminal equipment according to the configuration file. The command generating unit of the gateway uses the constructive command to control or access the terminal equipment through the read API or the write API.

The instant disclosure also provides a gateway used to generate a constructive command corresponding to at least one terminal equipment having a diversity of communication formats. The terminal equipment uses a communication protocol. The gateway has a read API, a write API, a command generating unit and a configuration file, and the configuration file comprises a read-write command for the terminal equipment. The command generating unit of the gateway generates the constructive command corresponding to the terminal equipment according to the configuration file. The command generating unit of the gateway uses the constructive command to control or access the terminal equipment through the read API or the write API.

The instant disclosure further provides a method for adding new terminal equipment, which is used in a gateway having a configuration file. The gateway generates a constructive command corresponding to the terminal equipment having a diversity of communication formats. The method for adding new terminal equipment comprises the steps as follows. First, receiving a read-write command corresponding to the terminal equipment. After that, setting the configuration file according to the read-write command Finally, a command generating unit of the gateway generates the constructive command according to the configuration file, and then controls or accesses the terminal equipment through a read API or a write API.

To sum up, via the system for controlling terminal equipment, the gateway and the method for adding new terminal equipment provided by the instant disclosure, a constructive command that can be used in all kinds of terminal equipment having a diversity of communication formats is generated according to a configuration file of newly added terminal equipment. The instant disclosure uses a uniform method to construct commands, so that the data log can be easily recorded by setting log flags. Thus, any error can be easily found in and removed from the transmitted data.

For further understanding of the instant disclosure, reference is made to the following detailed description illustrating the embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic diagram illustrating the connection between terminal equipment and a control apparatus in the prior art.

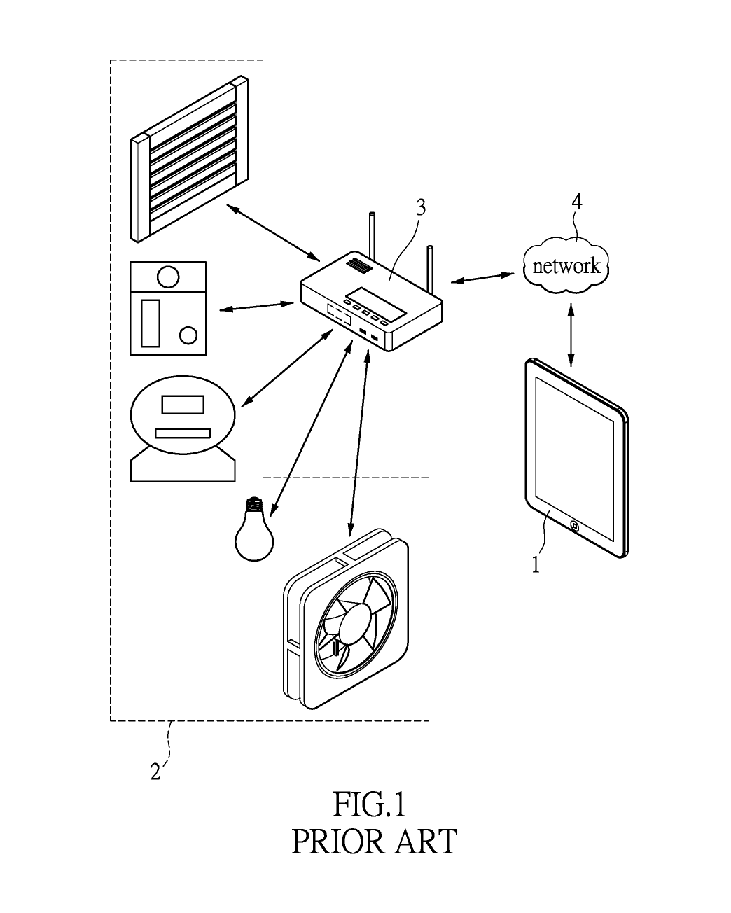

FIG. 2 shows a block diagram of a system for controlling terminal equipment of one embodiment of the instant disclosure.

FIG. 3 shows a schematic diagram listing write commands of a gateway of one embodiment of the instant disclosure.

FIG. 4 shows a schematic diagram listing read commands of a gateway of one embodiment of the instant disclosure.

FIG. 5 shows a flow chart of a method for adding new terminal equipment of one embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements, but these elements should not be limited by these terms. These terms are only to distinguish one element from another region or section discussed below and could be termed a second element without departing from the teachings of the instant disclosure. As used herein, the term “and/or” includes any and all combinations of one or more of the associated listed items.

[One Embodiment of a System for Controlling Terminal Equipment and a Gateway]

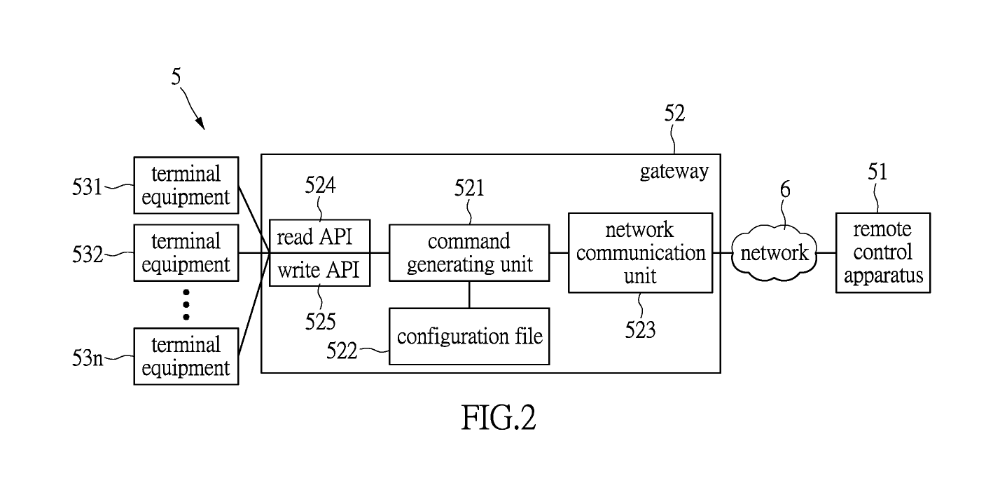

Refer to FIG. 2. FIG. 2 shows a block diagram of a system for controlling terminal equipment of one embodiment of the instant disclosure. The system for controlling terminal equipment 5 comprises at least one terminal equipment 531, 532, . . . , 53n and a gateway 52. The gateway 52 is coupled to the terminal equipment 531, 532, . . . , 53n. The gateway 52 communicates with the terminal equipment 531, 532, . . . , 53n in a wired way or a wireless way, and the gateway 52 controls or accesses the terminal equipment 531, 532, . . . , 53n. In addition, the system for controlling terminal equipment 5 further comprises a remote control apparatus 51. In this case, the gateway 52 can be a medium between the remote control apparatus 51 and the terminal equipment 531, 532, . . . , 53n, such that the remote control apparatus 51 can control or access the terminal equipment 531, 532, . . . , 53n through the gateway 52. As shown in FIG. 2, there is a plurality of terminal equipment 531, 532, . . . , 53n, but the amount of the terminal equipment is not limited herein. Each of the terminal equipment 531, 532, . . . , 53n uses a kind of communication protocol, and the communication protocols used by different terminal equipment may be different. The communication protocol can be, for example, the Zigbee communication protocol, the RS485 communication protocol, the RS232 communication protocol, the Modbus communication protocol, the Ethernet communication protocol or the like, and there is no restriction. The terminal equipment 531, 532, . . . , 53n can be, for example, automatic shutters, an IR adaptor, an electricity meter, a lamp, an exhaust fan, an IR sensor, a vibration sensor, a temperature sensor and the like.

In the following description, the situation that the gateway 52 directly controls the terminal equipment 531, 532, . . . , 53n is considered. There are various applications of the terminal equipment 531, 532, . . . , 53n, which provide various functions. For example, if the terminal equipment is a lamp the gateway 52 can set the luminance of the lamp. If the terminal equipment is an air-conditioner the gateway 52 can adjust the temperature of the air-conditioner. If the terminal equipment is an electricity meter the gateway 52 can read the electricity information recorded by the electricity meter, such as the single-phase data, the double-phase data or the triple-phase data, and the phase, power, voltage and current thereof. If the terminal equipment is automatic shutters, and the gateway 52 can control the switch thereof.

The gateway 52 can be an independent apparatus, and communicates with the terminal equipment 531, 532, . . . , 53n in a wired way or a wireless way. There is an automatic control program installed in the gateway 52 to automatically control or access the terminal equipment 531, 532, . . . , 53n. Also, a user interface can be installed in the gateway 52, such that a user can control or access terminal equipment 531, 532, . . . , 53n by the gateway. In another case, the gateway 52 can be implemented by a smart phone. More specifically, the gateway 52 can be implemented by a smart phone having an application installed. The smart phone, as the gateway 5, can communicate with the terminal equipment 531, 532, . . . , 53n. The terminal equipment 531, 532, . . . , 53n can be wearable terminal equipment to implement the smart control.

The following description is for further illustrating each function block of the gateway 52. The gateway 52 has a read API 524 and a write API 525. The read API 524 and the write API 525 may be a wireless communication interface or a wired communication interface, which depends on the connection between the gateway 52 and the terminal equipment 531, 532, . . . , 53n, and thus it is not limited herein.

In addition, the gateway 52 has a command generating unit 521 and a configuration file 522. The command generating unit 521 is coupled to the read API 524, the write API 525 and the configuration file 522. The configuration file 522 comprises read-write commands corresponding to the terminal equipment 531, 532, . . . , 53n. Specifically, the configuration file 522 generates a constructive command, and the command generating unit 521 executes the constructive command according to the configuration file 522. The constructive command comprises a write command and a read command, and has a diversity of communication formats. The constructive command will be illustrated in the later description. The command generating unit 521 can be implemented by a combination of the hardware circuit, software, hardware, firmware and the like. For example, the command generating unit 521 can be implemented by a micro control unit (MCU) or a central processing unit (CPU) that executes programs, and it is not limited herein. The command generating unit 521 of the gateway 52 generates the constructive command corresponding to the terminal equipment 531, 532, . . . , 53n according to the configuration file 522. After that, the command generating unit 521 of the gateway 52 controls or accesses the terminal equipment 531, 532, . . . , 53n through the read API 524 or the write API 525 according to the constructive command. The read command is transmitted to the terminal equipment 531, 532, . . . , 53n through the read API 524, and the write command is transmitted to the terminal equipment 531, 532, . . . , 53n through the write API 525.

In the following description, the situation that the remote control apparatus 51 is connected to the gateway 52 through a network 4 is considered. In this situation, the gateway 52 further comprises a network communication unit 523, wherein the network communication unit 523 is coupled to the command generating unit 521. The remote control apparatus 51 is connected to the gateway 52 through a network 6, and controls or accesses the terminal equipment 531, 532, . . . , 53n through the gateway 52. The network 6 can be, for example, the Internet or the local area network (LAN), and the type of the network 6 is not limited herein. If the remote control apparatus 51 is connected to the gateway 52 through the Internet or LAN, the network communication unit 523 of the gateway 52 can be connected to the remote control apparatus 51 under the TCP/IP communication protocol. The gateway 52 converts a TCP/IP write command (or a TCP/IP read command) transmitted by the remote control apparatus 51 to a write command corresponding to the write API 525 (or a read command corresponding to the read API 524) according to the configuration file 522, and transmits the write command corresponding to the write API 525 (or the read command corresponding to the read API 524) to the terminal equipment 531, 532, . . . , 53n. In another case, the gateway 52 also can convert a response message, transmitted through the write API 525 or the read API 524 by the terminal equipment 531, 532, . . . , 53n, to a TCP/IP data according to the configuration file 522, and transmit the TCP/IP data to the remote control apparatus 51.

In one embodiment, the remote control apparatus 51 can be, for example, a network server, a user computer, or a user mobile communication device. If the remote control apparatus 51 is a network server, the network server can automatically and remotely control and access each terminal equipment 531, 532, . . . , 53n. If the remote control apparatus 51 is a user computer, the user can remotely control and access each terminal equipment 531, 532, . . . , 53n. For example, if the user computer is a smart phone, the remote control apparatus 51 can be implemented by the application installed in the smart phone. The above examples are for illustrating the remote control apparatus 51 but not for restricting the implementation of the remote control apparatus 51.

The following description is for illustrating the constructive command executed by the command generating unit 521 according to the configuration file 522. The constructive command can be a write command or a read command. The constructive command of the configuration file 522 comprises the type of the terminal equipment, at least one command, the number of the terminal equipment, at least one designated value, an error checking code and the like. Moreover, the constructive command of the configuration file 522 may further comprise a map key which indicates controlling or accessing the terminal equipment. The map key may be a map key for a write command or a response key for a read command If the types of constructive commands do not include a read-write command of the newly added terminal equipment, the map key of the constructive command can be determined according to the read-write commands of the newly added terminal equipment. This determined map key can be the read-write command of the newly added terminal equipment.

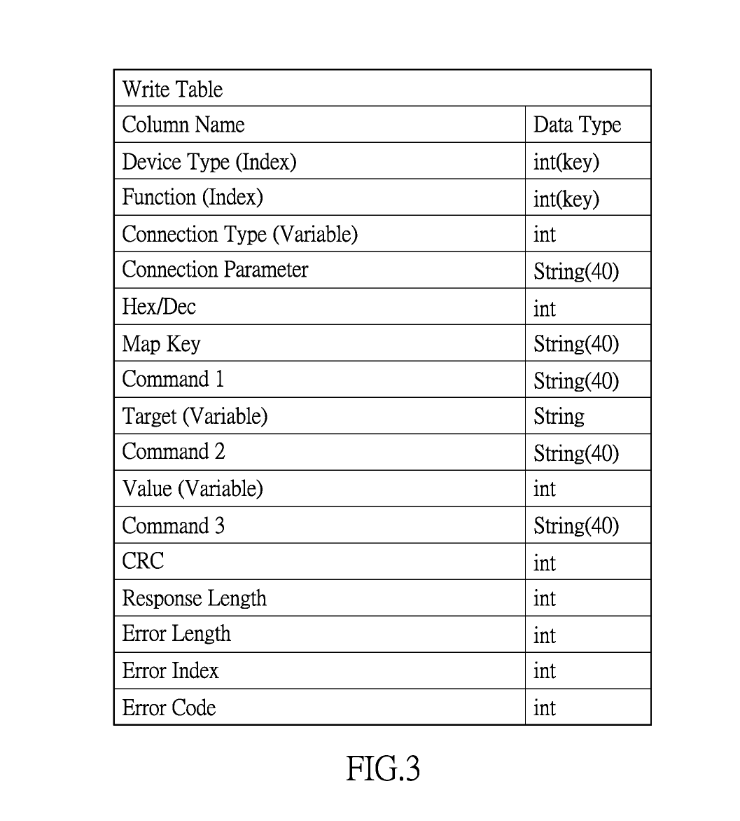

Refer to FIG. 3. FIG. 3 shows a schematic diagram listing write commands of a gateway of one embodiment of the instant disclosure. The write command is used to control the terminal equipment. The write commands may comprise commands indicating, for example, the equipment type (index), the command function of the equipment (index), the connection type (variable), the connection parameter, the positional notation (Hex/Dec), the map key, at least one command including the target (variable) and the variable data (variable) and the error checking code. At least one command mentioned above is represented by three commands listed in the table shown in FIG. 3. Taking a lamp as an example of the controlled terminal equipment, when setting the luminance of the lamp, the string of the Target after the Command 1 “01;16;02” represents for the light number (the data type of the target is an integer), the string of the Value after the Command 2 “00;01;02;00” represents for the brightness of the lamp (the data type of the Value is an integer), and the error checking code is after the Command 3, such as a cyclic redundancy check (CRC) code. In practice, the error checking code may be a CRC10 code or a CRC16 code. Taking an air-conditioner as another example of the controlled terminal equipment, when setting the temperature of the air-conditioner, the string of the Target after the Command 1 “01;16” represents for the air-conditioner number, the string of the Value after the Command 2 “1b;00” represents for the temperature, and the error checking code after the Command 3 is a CRC16 code. Taking automatic shutters as another example of the controlled terminal equipment, the command string for opening the automatic shutters is, for example, “0;1;1;0;0;0;0;0”, and taking a visitor counter as still another example of the controlled terminal equipment, the command string for returning to zero is, for example, “66;12;12;35;00;10;00;00;0b;00;00;00;00;00;00;00;00;00;00;00;F8 01;05;00;00;00;43;00;00;00;BF”.

The other write commands listed in the table shown in FIG. 3 may represent the determination of the communication protocol, the specific communication, the coding, the response value, the response message or the like. The determination of the communication protocol can be described by the strings representing the connection type and the connection parameter. The specific communication can be indicated by the map key. The coding can be written in, for example, the integer characters representing the positional notation. The response value and the response message may be, for example, the byte length of the response (such as the Response Length listed in the table shown in FIG. 3), the byte length of the error response (such as the Error Length listed in the table shown in FIG. 3), the index position of the error code and the error code. However, the contents of the write commands are not limited herein.

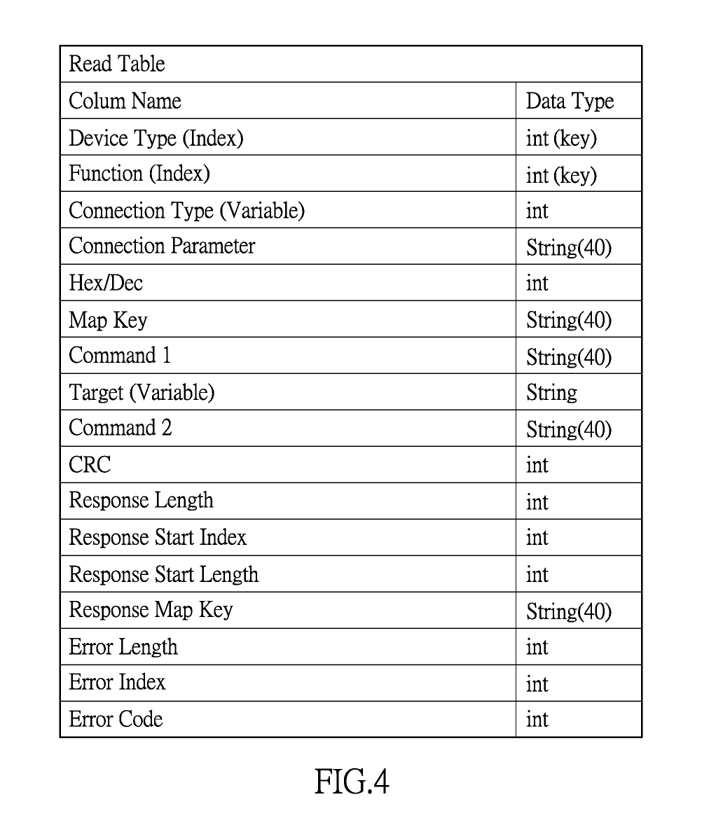

Refer to FIG. 4. FIG. 4 shows a schematic diagram listing read commands of a gateway of one embodiment of the instant disclosure. The write command is used to control the terminal equipment. The read commands may comprise commands indicating, for example, the equipment type (index), the command function of the equipment (index), the connection type (variable), the connection parameter, the positional notation (Hex/Dec), the map key, at least one command and the error checking code. At least one command mentioned above is represented by two commands listed in the table shown in FIG. 4.

Take a lamp as an example of the controlled terminal equipment. When reading the status information of the light, the string of the Target after the Command 1 “01;03;02” represents for the light number to be read (the data type of the Target is an integer), and the error checking code is after the string of the Command 2 “00;01”, such as a CRC code. In practice, the CRC code is a CRC10 code or a CRC16 code. Take an air-conditioner as an example of the controlled terminal equipment. When reading the set temperature, the string of the Target after the Command 1 “01;03” represents the air-conditioner number to be read (the data type of the Target is an integer), and the error checking code is after the string of the Command 2 “1b;00;01”, such as a CRC16 code. Take a visitor counter as another example of the controlled terminal equipment, the string for reading the counting number of the visitor counter is “66;12;12;35;20;00;00;00;00;00;00;00;00;00;00;00;00;00;00;00”.

The other read commands listed in the table shown in FIG. 4 represents the determination of the communication protocol, the specific communication, the coding, the response value, the response message or the like. The determination of the communication protocol can be described by the strings indicating the connection type and the connection parameter. If there is a specific communication, it can be described by the map key. The coding can be written in, for example, the integer characters indicating the positional notation. The response value and the response message may be, for example, the byte length of the response (such as the Response Length listed in the table shown in FIG. 4), the byte length of the error response (such as the Error Length listed in the table shown in FIG. 4), the index position of the error code and the error code. However, the contents of the read commands are not limited herein. Additionally, the gateway can store the message log of the write command or the read command, to make a record and remove errors.

[One Embodiment of a Method for Adding New Terminal Equipment]

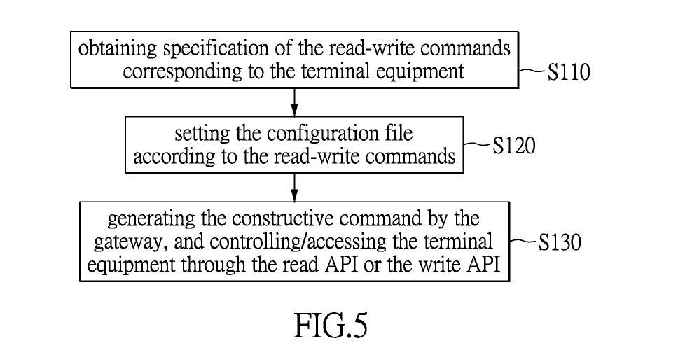

Refer to FIG. 5. FIG. 5 shows a flow chart of a method for adding new terminal equipment of one embodiment of the instant disclosure. The method for adding new terminal equipment is used in a gateway having a configuration file. The gateway is coupled to at least one terminal equipment, and generates a constructive command corresponding to the terminal equipment having a diversity of communication formats. The gateway can directly control the terminal equipment, or can be a medium between a remote control apparatus and the terminal equipment. The above description has illustrated the gateway in detail, and thus the redundant information is not repeated. Each time when there is new terminal equipment to be added and to be connected to the gateway, this method for adding new terminal equipment described as follows can be applied. First, in Step S110, receiving a format document including a read-write command corresponding to the terminal equipment within the text thereof. The format document can be a paper document or an electric file, which is not limited herein. The read-write command of the terminal equipment in Step 110 is determined according to the newly added terminal equipment.

Once the read-write command of the newly added terminal equipment is known, for example, from the specification of the newly added terminal equipment, the command generating unit of the gateway can use the constructive command to generate and execute the read-write command of the newly added terminal equipment. Thus, in Step S120, sets the configuration file according to the read-write command. Specifically, Step S120 determines how the configuration file is updated for generating an updated configuration file that can be used to generate a constructive command corresponding to the newly added terminal equipment. In practice, an operator of the gateway (such as an engineer or a maintenance staff) can input an added command row via a user interface into the configuration file so as to update or add the configuration file, wherein the added command row corresponds to the newly added terminal equipment. The command row can be one row in the above described write command table or read command table. Each time when there is newly added terminal equipment, there is a command row that can be updated or added into the configuration file, but it is not limited herein. Step S120 can also be executed by an automatic control program, to update the configuration file according to the format document including the read-write command. Finally, in Step S130, the command generating unit of the gateway generates a constructive command according to the configuration file, and then controls or accesses the terminal equipment via the read API or the write API. Refer to the above descriptions illustrating FIG. 3 and FIG. 4. The constructive command can be a write command or a read command. Moreover, as described above, the constructive command can further comprise the map key of the newly added terminal equipment. If the types of constructive commands do not include the read-write commands of the newly added terminal equipment, the map key of the constructive command can be determined according to the read-write commands of the newly added terminal equipment. Thus, the gateway can use the constructive command to control or access the newly added terminal equipment. In addition, the remote control apparatus can be connected to the gateway, and control or access the newly added terminal equipment through the gateway. In addition, the gateway can store the message log of the write command or the read command, to make a record and to remove errors.

To sum up, via the system for controlling terminal equipment, the gateway and the method for adding new terminal equipment, a constructive command that can be used in all kinds of terminal equipment having a diversity of communication format is generated according to a configuration file of a newly added terminal equipment. Generally, the format of the newly added terminal equipment is described in its specification, so that the engineer can update the configuration file manually according to the specification or automatically via the automatic control program, to quickly add terminal equipment. Moreover, the instant disclosure uses a uniform method to construct commands, so that the data log can be easily recorded by setting a log flag. Thus, any error can be easily found in the transmitted data, which reduces the difficulty of removing the error.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A system for controlling terminal equipment, comprising:
at least one terminal equipment, using a communication protocol; and
a gateway, coupled to the terminal equipment, generating a constructive command corresponding to the terminal equipment having a diversity of communication formats, the gateway having a read API, a write API, a command generating unit and a configuration file, the configuration file comprising a read-write command for the terminal equipment;
wherein the command generating unit of the gateway generates the constructive command corresponding to the terminal equipment according to the configuration file, the command generating unit of the gateway uses the constructive command to control or access the terminal equipment through the read API or the write API.

2. The system for controlling terminal equipment according to claim 1, wherein the constructive command of the configuration file comprises the type of the terminal equipment, at least one command, the number of the terminal equipment, at least one designated value and an error checking code.

3. The system for controlling terminal equipment according to claim 1, wherein the constructive command of the configuration file further comprises a map key.

4. The system for controlling terminal equipment according to claim 1, wherein the constructive command of the configuration file is a write command or a read command.

5. The system for controlling terminal equipment according to claim 1, wherein the communication protocol is the Zigbee communication protocol, the RS485 communication protocol, the RS232 communication protocol, the Modbus communication protocol or the Ethernet communication protocol.

6. The system for controlling terminal equipment according to claim 1, wherein the gateway is a medium between a remote control apparatus and the terminal equipment, the remote control apparatus is connected to the gateway through a network, and controls or accesses the terminal equipment through the gateway.

7. The system for controlling terminal equipment according to claim 1, wherein the gateway stores a message log of the constructive command.

8. The system for controlling terminal equipment according to claim 6, wherein a network communication unit of the gateway is connected to the remote control apparatus under the TCP/IP communication protocol.

9. A gateway, used to generate a constructive command corresponding to at least one terminal equipment having a diversity of communication formats, wherein the terminal equipment uses a communication protocol, the gateway has a read API, a write API, a command generating unit and a configuration file, the configuration file comprises a read-write command for the terminal equipment, the command generating unit of the gateway generates the constructive command corresponding to the terminal equipment according to the configuration file, and the command generating unit of the gateway uses the constructive command to control or access the terminal equipment through the read API or the write API.

10. The gateway according to claim 9, wherein the constructive command of the configuration file comprises the type of the terminal equipment, at least one command, the number of the terminal equipment, at least one designated value and an error checking code

11. The gateway according to claim 10, wherein the constructive command of the configuration file further comprises a map key.

12. The gateway according to claim 9, wherein the constructive command of the configuration file is a write command or a read command.

13. The gateway according to claim 9, wherein the gateway is a medium between a remote control apparatus and the terminal equipment, the remote control apparatus is connected to the gateway through a network, and controls or accesses the terminal equipment through the gateway.

14. The gateway according to claim 9, wherein the gateway stores a message log of the constructive command.

15. A method for adding new terminal equipment, used in a gateway having a configuration file, the gateway generating a constructive command corresponding to the terminal equipment having a diversity of communication formats, the method for adding new terminal equipment comprising:
receiving a read-write command corresponding to the terminal equipment;
setting the configuration file according to the read-write command; and
generating the constructive command according to the configuration file, and controlling or accessing the terminal equipment through a read API or a write API, by a command generating unit of the gateway.

16. The method for adding new terminal equipment according to claim 15, wherein the constructive command of the configuration file comprises the type of the terminal equipment, at least one command, the number of the terminal equipment, at least one designated value and an error checking code.

17. The method for adding new terminal equipment according to claim 15, wherein the constructive command of the configuration file further comprises a map key.

18. The method for adding new terminal equipment according to claim 15, wherein the constructive command of the configuration file is a write command or a read command.

19. The method for adding new terminal equipment according to claim 15, wherein the gateway is a medium between a remote control apparatus and the terminal equipment, the remote control apparatus is connected to the gateway through a network, and controls or accesses the terminal equipment through the gateway.

20. The method for adding new terminal equipment according to claim 15, further comprising:
storing a message log of the constructive command.
